(19) United States
(12) Patent Application Publication
(10) Pub. No.: US 2012/0189446 A1
(43) Pub. Date: Jul. 26, 2012

(54) Horizontal wind turbine with a vertical shaft

(76) Inventor: Myrl J. Saarem, (US)

(21) Appl. No.: 12/930,922

(22) Filed: Jan. 21, 2011

(51) Int. Cl. F03D 7/02

(52) U.S. Cl. 416/13

(57) ABSTRACT

A horizontal wind turbine with a vertical shaft and wind driven vanes that hang vertically when there is no wind, engage and drive the turbine when traveling with the wind and rotate toward a horizontal position when traveling into the wind.

### Background

1. Field of Invention

This invention relates to wind turbines, specifically a wind turbine that rotates in a horizontal plane and has a vertical output shaft and is used for the extraction and conversion of wind energy.

2. Description of Prior Art

Cost and undesirable emissions of fossil fuel energy have generated the development of a wide variety of wind turbine devices. Most prominent are vertical rotation machines with long vanes. This requires that the hub of the vane rotating mechanism must be located at a high level above the ground to allow vane rotation and prevent interference and possible injury to items at ground level.

One way to avoid this problem is to make the turbine rotate in a horizontal plane. The well known anemometer is commonly used as a wind velocity meter and rotates horizontally (U.S. Pat. No. 3,020,963 to Hakkarinen). The cup-like drivers offer substantial wind resistance in the open-cup position and less resistance in the reverse-cup position. Hence, horizontal rotation occurs when there is wind. However, the reverse-cup wind resistance makes the device impractical for efficient energy capture when returning into the wind. U.S. Pat. No. 3,897,170 to Darvishian addresses this problem by streamlining the reverse cup configuration.

It is desirable to overcome this returning wind resistance. U.S. Pat. No. 4,377,372 to Stutzman (1983) illustrates such a device. This patent describes a folded vane combination that folds to present a low wind resistance when traveling into the wind but unfolds to capture the wind energy when traveling with the wind. Other folding vane patents include U.S. Pat. No. 665,891 to Fetty, U.S. Pat. No. 1,915,689 to Moore, U.S. Pat. No. 5,570,997 to Pratt and U.S. Pat. No. 6,929,450 to Noble. All these systems require mechanisms to cause folding and unfolding the vanes.

### PRESENT INVENTION

### Objects and Advantages

Accordingly, the present wind turbine invention provides an energy producing machine provided by a wind generated rotating horizontal platform that drives a vertical shaft. The platform rotation is caused by wind contact with vanes that are hinged to the platform. On the platform side where the rotation direction is the same as the wind direction, the vanes are hinged vertically and are in drivable contact with the platform and therefore create the force to rotationally drive the platform. On the opposite side of the platform where the rotation direction is opposite to the wind direction, the hinged vanes are driven toward a horizontal position producing minimal wind resistance. If there is no wind, the vanes all hang in a vertical position.

Thus the present invention provides a simple and economical horizontal wind turbine with a vertical drive shaft.

### DRAWINGS AND FIGURES

FIG. 1 shows a plan view of the horizontal platform in the form of a wheel with noted wind direction.

FIG. 2 shows a side view of the wheel with the vane positions in the wind.

FIG. 3 shows a cross section of the wheel platform through the section 3-3 noted in FIG. 1.

FIG. 4 shows a plan view of an alternate platform using spokes.

FIG. 5 shows a cross section of the alternate platform through section 5-5 in FIG. 4.

FIG. 6 shows a cross section of stacked platforms.

FIG. 7 shows a plan view of one hinge design.

FIG. 8 shows a cross section of the hinge of FIG. 7.

### DESCRIPTION

### FIGS. 1 to 8

In FIG. 1 the platform 10 is described as a wheel 12 consisting of a rim 14 with multiple spokes 16. One end of spoke 16 is attached to rim 14 and the other end is attached to hub 18. Attachment can be made by welding, brazing, fasteners and the like.

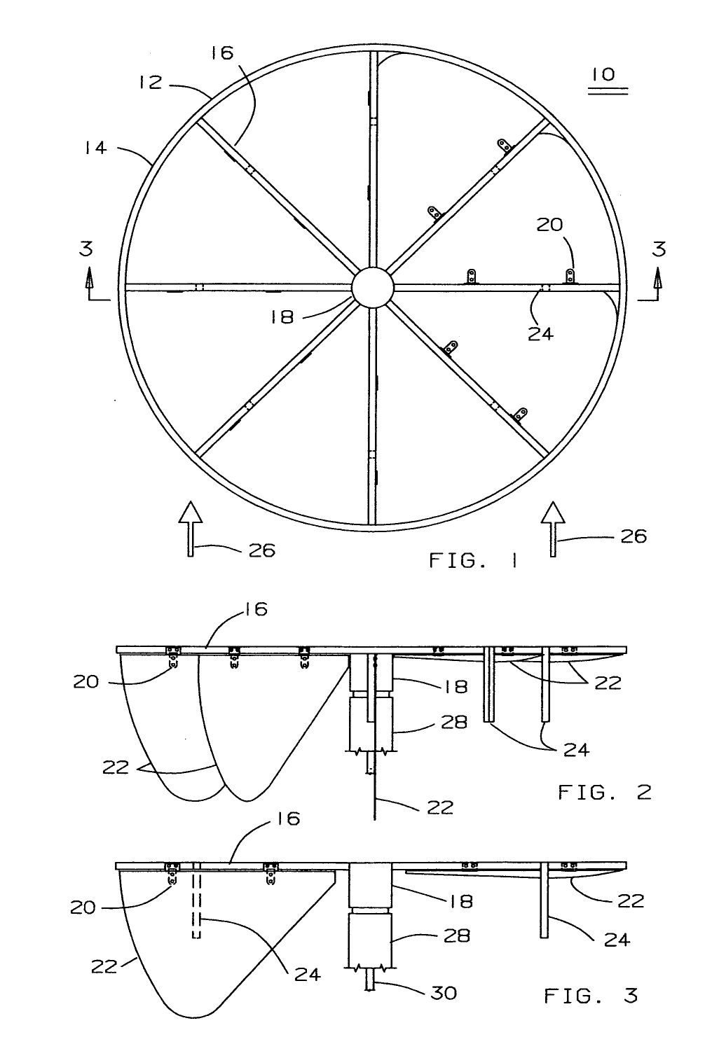

In FIG. 2 hinges 20 attach vanes 22 to spokes 16. Stops 24 restrict the rotation of hinged vanes 22 to approximately 90 degrees, such as being vertical when wind 26 is in the direction of rotation and nearly horizontal when the wind is opposite of the direction of rotation.

In FIG. 3 wind forces (see FIG. 1) in the direction of rotation, drive vanes 22 into forcible contact with stop 24. This force is transmitted to spoke 16, hub 18, and finally to shaft 30 which is rigidly attached to hub 18, all of which are therefore caused to rotate. Wind forces opposite to the direction of rotation drive the vanes 22 away from stops 24 toward a horizontal position, thus reducing rotational wind friction resistance. Vanes 24 are constructed of suitable material that is light in weight but is strong enough to deter detrimental deformation. When there is no wind, all the vanes 22 hang to a vertical position. The entire system is supported by vertical support 28 which contains axial and radial bearing support and positions the entire rotating mechanism to a desired elevation.

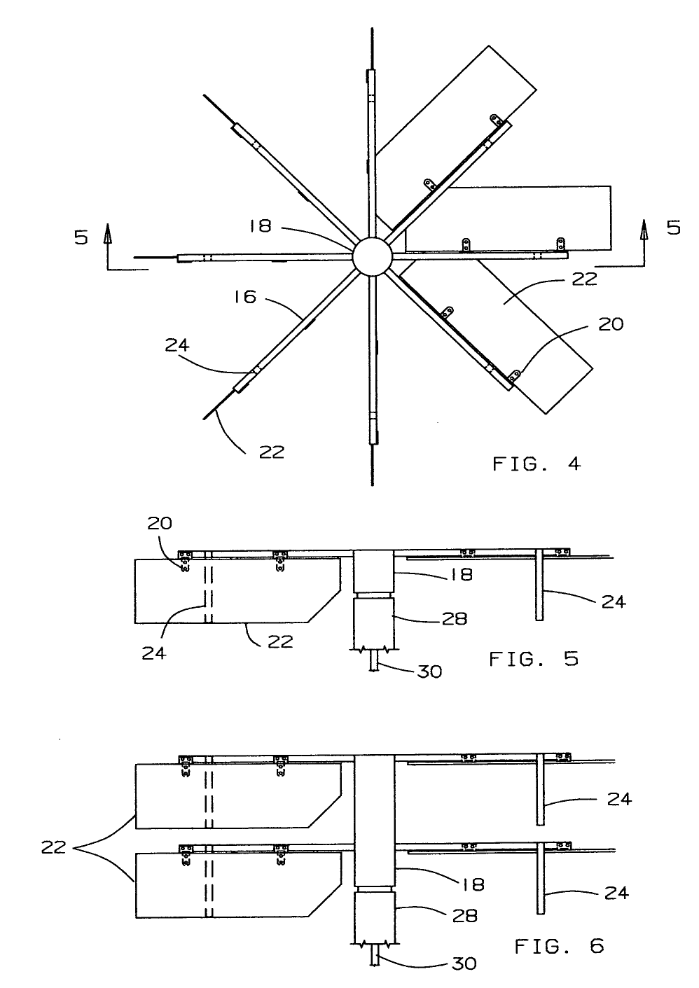

In FIG. 4 another vane support structure is shown using spokes 16. As an alternative, a thin flat circular disc could be used as a support structure for the hinged vanes 22. This invention applies to all support structures that allow the attachment and function of the hinged vanes 22.

In FIG. 5 another configuration of the vanes 22 is shown. This configuration conserves vertical space. Vanes 22 may take on a variety of shapes. Vanes 22 are shown as being flat, but may take on a variety of other shapes that enhance forces of gravity and transmission of wind forces.

In FIG. 6 two vane support structures are shown stacked to capture and transfer more wind energy to hub 18. The vane support structures may rotate in opposite directions and be connected to concentric drivers. Although two vane support structures are shown, more than two are possible.

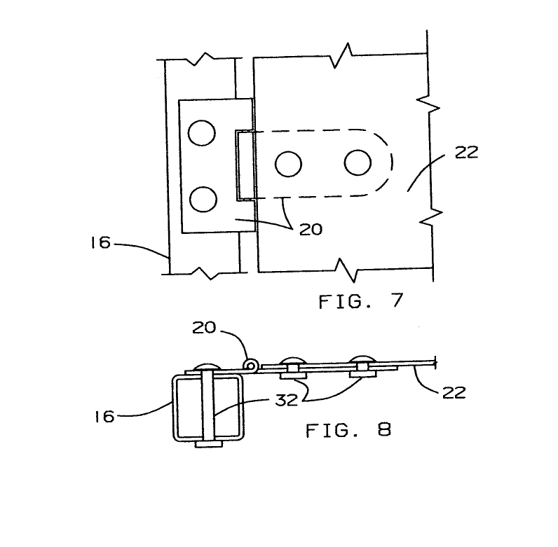

FIG. 7 and FIG. 8 show a possible hinge configuration. Hinge 20 is shown attached to spoke 16 and vane 22 using rivets 32. Other means of attachment may be used. Any hinge device that allows planar rotation of vane 22 may be used.

### OPERATION

Vanes hang from a rotatable support system when there is no wind. However, when the wind blows, vanes on one side (side 1) of the support system are forced into contact with a stop which imparts rotational wind force to the rotatable support system. Vanes on the opposite side (side 2) are buoyed up toward a horizontal position, hence, offering little rotational resistance. During rotation, as a vane passes form side 2 to side 1, gravity causes the vane to drop from the near horizontal position to vertical position and to come in contact with the stop. The stop positions the vane in a near vertical position and transmits the wind contact force to the rotatable support system.

### CONCLUSION

Thus a wind turbine is provided that:
a) is simple to construct,
b) contains no complicated mechanisms to orient driving mechanisms,
c) is economical to construct,
d) can be positioned at a lower elevation than conventional vertical wind turbines,
e) can be easily stacked to produce more power,
f) has horizontal rotation, and
g) depends entirely on the natural resources of wind and gravity for operation.

It will be appreciated that while particular embodiments of the invention have been shown and described, modification may be made. It is intended in the claims to cover all modifications that come within the true spirit and scope of the invention.

I claim:

1. A horizontal rotating wind turbine comprising:
a) a supporting structure means that rotates horizontally
b) a plurality of vanes
c) hinge means joining said vanes to said supporting structure
d) a positioning means that causes said vanes to forcibly contact said supporting structure means when rotating with the direction of the wind
e) a hub attached to and rotates with said supporting structure means, and
f) a shaft attached to said hub and rotates with said supporting structure means, said shaft being the center of said rotation.
Whereby, said vanes drop to a vertical position due to gravity and transmit rotational force to said structure when rotating with the wind, and adjust to a more horizontal position with less wind resistance when rotating into the wind.

2. The horizontal rotating wind turbine of claim 1 wherein said rotating wind turbine is stacked to produce a plurality of said wind turbines connected to one said hub.
